(19) United States
(12) Patent Application Publication
(10) Pub. No.: US 2003/0193651 A1
(43) Pub. Date: Oct. 16, 2003

(54) Projection system

(76) Inventor: Frank Egle, Neu-Ulm (DE)

Correspondence Address: Stephan A. Pendorf, Pendorf & Cutliff, P.O. Box 20445, Tampa, FL, 33622-0445, US

(21) Appl. No.: 10/411,903

(22) Filed: Apr. 11, 2003

(30) Foreign Application Priority Data
Apr. 11, 2002 (DE) 102 15 893.2-51

(51) Int. Cl. G03B 21/00

(52) U.S. Cl. 353/31

(57) ABSTRACT

A projection system for optical reproduction of information or entertainment data for employment in the area of passenger transport (airplane, automobile area). Therein a laser projector is used for generating an image line by line upon surfaces within the vehicle internal space. By rotation or pivoting of the laser projector or displacement along a guide rail practically all surfaces in the internal space of the vehicle can be reached.

### BACKGROUND OF THE INVENTION

1. Field of the Invention

The invention concerns projection systems for optical display of information or entertainment data. In particular, the invention concerns projection devices for employment in the area of passenger transport (airplanes, trains, automotive fields).

2. Description of the Related Art

Systems of this type are increasingly used as alternatives to monitors and can be employed in vehicles for display of information (navigation data, internet), or entertainment (display of videos) and for communication purposes (video telephone).

German Gebrauchsmuster No. 200 18 644.2 describes such a device for projection of image data and intended for use in vehicles. This system is comprised of a projection surface attached to the ceiling on the inside of the vehicle, which can be mechanically unfolded or unrolled, and a projector installed behind the viewing vehicle occupants, for example behind the rear seats or on the vehicle ceiling.

The device disclosed in this Gebrauchsmuster has the disadvantage, that for image display a projection surface must be specially provided for this purpose (for example a projection screen). In order that this projection surface is fully exposed only for the time of image display in the—spatially limited—internal area of the vehicle, in this system an unfolding or unrolling mechanism is provided for the projection surface.

Besides this, the fixed positioning of projector and projection surface relative to each other defines only one optimal projection angle for the viewing position of the viewers.

### SUMMARY OF THE INVENTION

Beginning with this state of the art, it is the task of the present invention to develop an improved projection device for display of visual information and entertainment data, which substantially overcomes the above-mentioned disadvantages and provides further advantages.

### DETAILED DESCRIPTION OF THE INVENTION

This task is solved with a projection system for display of optical information and entertainment data in passenger vehicles, comprising a laser projector for projecting an image, the laser projector including an integrated deflector via which one or more laser beams are directed in a scanning manner upon a projection surface within the internal area of the passenger vehicle, wherein the projection surface in the passenger vehicle is a surface of a conventional interior structure, in particular headrests, seatbacks, door molding or upholstery, or the dashboard.

In the inventive projection device, a laser projector is employed for projection. In contrast to a conventional projector, here the display of the image occurs by the scanning of one or more laser beams, so that the image is constructed line-by-line of individual image points (pixels), as for example in the case of a PC or TV monitor. Therein by the selection of the number of lines and the pixel density the resolution of the reproduced image can be varied broadly.

Likewise, with such a laser projector the image size can be varied over a broad range, since it is only dependent upon the respectively selected maximal X and Y control values of the laser deflector device integrated in the projection head (for example reflecting oscillating mirror system).

In the inventive system the image projection can occur upon a projection surface specially provided for this (for example, an extendable projection screen); however, it could also be on another surface already provided in the internal space in conventional manner (dashboard, headrests, backrests, door upholstery, ceiling upholstery). For this, the only requirement is that the respective surfaces are so designed, that they exhibit a sufficient reflectivity for the employed laser light.

In a further refined embodiment, it becomes possible by an appropriate control of the laser deflector device of the projection head to carry out a distortion correction of the displayed image. Therewith, for example, pillow or drum shaped distortions of the reproduced image, brought about by projection upon concave or convex bowed surfaces (for example, convex surfaces of a headrest) can be compensated for, just as in the case of trapezoid shaped distortion of the image in the case of diagonal or tangential projection.

In the case of a predefined menu of surfaces of the internal space which are available for a reproduction, the respective correction parameters can be measured one time at the plant and later be made available as stored data.

One advantage thereof is comprised in the possibility that, even in the case that the position of the projector remains unchanged (for example on the ceiling of the vehicle), the direction of projection and therewith the location of the projected image may be freely selected by appropriate control of the deflection system over a relatively wide area. With such a device it comes possible to individually adjust the image reproduction position optimally for an individual viewer.

A further particularity of the inventive system is comprised therein, that having only one laser projector it becomes possible to simultaneously project two (or more) different visual data sets to different positions (for example one reproduction of internet data for the left rear passenger and simultaneously a video reproduction for the right rear passenger). For this the laser deflector device of the projector is so controlled, that with an appropriate reflection angle a relatively large field can be painted (for example across the left or as the case may be right backrest of the front seats), wherein however a light emission occurs only during the passing over of the different partial area (respective seatbacks) with the associated image data.

A significant broadening of the projection area can be achieved when the laser projector is mounted to be rotatable and pivotable. In the case of a rotatability about 360° and a maximal pivot angle of 90° practically all conceivable locations in a vehicle can be accessed for image projection.

In a further preferred embodiment the position of the laser projector is variable within the internal space, for example using a conveyor mechanism for conveying along a guide rail. If image information is offered to the driver or passenger, then the projection head of the laser projector moves along the guide rail on the roof towards the front and projects the desired information for example on the dashboard. If subsequently the passengers in the rear area would like to view a movie, then this is possible by a rotation of the projection head about 180° towards the rear, by back projection onto an available projection screen (for example, an electrically extendable screen mounted on the vehicle ceiling). If no projection screen is provided, then in the alternative the projection head can travel along the guide rail towards the rear and the image reproduction can occur for example by projection onto the backside of the driver seat or as the case may be the seatback of the front passenger.

In the case that image reproduction is to occur simultaneously for the front and rear occupants, then the employment of two (or more) independently controllable laser projectors is possible.

The laser sources available today produce very high light intensities, so that with the inventive system a contrast rich image projection is achieved, which is easily viewed even under daylight conditions. At the same time the sources (for example laser-LEDs) are very small and light, so that the inventive projector, due to its small volume, is not considered to be an imposition in the limited internal space of the vehicle.

Also for safety aspects this system offers advantages. The small dimensions and the low weight of the projector contribute in the case of an accident substantially to reduction in injuries.

Further, the possibility to dispense with special projection screens (with corresponding folding or rolling mechanisms) serves for elevating the crash safety.

Basically the inventive system offers the advantages of a substantially unlimited free selection of projection or as the case may be visualization areas, since with appropriate equipping an image display can occur on almost all suitable surfaces within the internal space of the vehicle.

1. Projection device for reproduction of optical information and entertainment data in passenger transport means, thereby characterized, that for image production a laser projector is available, which includes an integrated deflection device, via which one or more laser beams are directed as a grid upon projection surfaces within the internal area of the passenger transport means, wherein the projection surfaces in the passenger transport means are formed by conventionally present internal structures, in particular by headrests, seatbacks, door molding or upholstery or dashboard.

2. Projection device according to claim 1, thereby characterized, that the laser projector includes a rotation or pivot device, by means of which the direction of projection can be changed.

3. Projection device according to claim 1 or 2, thereby characterized, that the projection device includes a displacement mechanism (for example one or more rails), by means of which the position of the laser projector can be varied in the internal space of the passenger transport means.

4. Projection device according to one of claims 1 through 3, thereby characterized, that means are available, via which, in the case of diagonal projection or nonplanar projection surfaces, the deflection device of the laser projector is controllable in such a manner that the compensation of the distortion brought about by the diagonal projection or as the case may be nonplanar projection surfaces, occurs.

5. Projection device according to one of claims 1 through 4, thereby characterized, that means are available, via which, in the case of diagonal projection or nonplanar projection surfaces, the deflection device of the laser projector is controllable in such a manner that the compensation of the distortion brought about by the diagonal projection or as the case may be nonplanar projection surfaces, occurs.
